(19) United States
(12) Patent Application Publication
(10) Pub. No.: US 2023/0322611 A1
(43) Pub. Date: Oct. 12, 2023

(54) ENAMEL COMPOSITION ENSURING EXCELLENT THERMAL SHOCK RESISTANCE, PREPARATION METHOD THEREOF AND COOKING APPLIANCE

(71) Applicant: LG ELECTRONICS INC., Seoul (KR)

(72) Inventors: Ju Hyeong KIM, Seoul (KR); Jaekyung YANG, Seoul (KR); Taehee KIM, Seoul (KR); Jaeyoung SHIN, Seoul (KR); Yongsoo LEE, Seoul (KR)

(21) Appl. No.: 18/124,678

(22) Filed: Mar. 22, 2023

(30) Foreign Application Priority Data
Mar. 22, 2022 (KR) 10-2022-0035310

(51) Int. Cl. A47J 36/04; F24C 15/00; C03C 8/20; H05B 3/74

(52) U.S. Cl. CPC C03C 8/20; A47J 36/04; F24C 15/005; H05B 3/74; C03C 2207/00; C03C 2217/78

(57) ABSTRACT

An enamel composition for a cooking appliance is prepared by a preparation method. The enamel composition includes glass frits, a siloxane-based compound, a silane-based compound, and mill addition. The mill addition includes one or more materials selected from a group comprised of SiO₂, Al₂O₃, ZrO₂, and TiO₂, thereby suppressing defects such as chipping even when the enamel composition is used at high temperature, for pyrolysis of contaminants.

### CROSS-REFERENCE TO RELATED APPLICATION

This application claims priority to and the benefit of Korean Patent Application No. 10-2022-0035310, filed on Mar. 22, 2022, the disclosure of which is incorporated herein by reference in its entirety.

### TECHNICAL FIELD

Disclosed herein are an enamel composition ensuring an excellent cleaning function and excellent thermal shock resistance, a preparation method thereof and a cooking appliance.

### BACKGROUND

Enamel is a substance where a glass glaze is applied onto the surface of a metal plate. Ordinary enamel is used for a cooking appliance such as a microwave oven and an oven, and the like. Cooking appliances such as an electric oven, a gas oven and the like are devices that cook food using a heat source. Contaminants and the like, produced during cooking, are attached to the inner wall of the cavity of a cooking appliance. Accordingly, the inner wall of the cavity needs to be cleaned. Enamel is coated on the inner wall surface of the cavity of a cooking appliance, and the like, and helps to remove contaminants attached to the cooking appliance easily. Among the technologies for readily cleaning the inner wall of a cavity, the process of pyrolysis (thermal decomposition) by which contaminants are burned to ashes at high temperatures is widely known. The process of pyrolysis (thermal decomposition) can be applied to enamel compositions including components such as P₂O₅, SiO₂, B₂O₃ and the like.

The pyrolysis (thermal decomposition) process described above is performed at 450 to 500° C. However, while temperature drops from high temperature to room temperature, residual stress occurs due to a difference between the coefficient of thermal expansion of a base material and the coefficient of thermal expansion of enamel, and the residual stress causes defects such as chipping on the surface of the enamel.

### SUMMARY

The objective of the present disclosure is to provide a novel enamel composition ensuring an excellent cleaning function and excellent thermal shock resistance.

The objective of the present disclosure is to provide a noel enamel composition causing no defects such as chipping although the enamel composition is used at high temperature, for pyrolysis of contaminants.

The objective of the present disclosure is to provide a preparation method of an enamel composition ensuring the cleaning function and thermal shock resistance described above.

Aspects according to the present disclosure are not limited to the above ones, and other aspects and advantages that are not mentioned above can be clearly understood from the following description and can be more clearly understood from the embodiments set forth herein. Additionally, understandably, the aspects and advantages in the present disclosure are embodied via means and combinations thereof that are described in the appended claims.

To provide an enamel composition ensuring an excellent cleaning function and excellent thermal shock resistance, an enamel composition according to the present disclosure comprises glass frits, a siloxane-based compound, a silane-based compound, and mill addition.

Specifically, the enamel composition according to the present disclosure comprises mill addition comprising one or more that is selected from a group comprised of SiO₂, Al₂O₃, ZrO₂ and TiO₂. Preferably, the enamel composition may comprise 85 to 99.75 wt% of the glass frits, 0.1 to 2.5 wt% of the siloxane-based compound, 0.05 to 2.5 wt% of the silane-based compound, and 0.1 to 10 wt% of the mill addition.

Additionally, the mill addition may have a particle size of 50 to 100 µm, preferably.

An enamel composition according to the present disclosure ensures an excellent thermal shock resistance as well as an excellent cleaning function.

The enamel composition causes no defects such as chipping although the enamel composition is used at high temperature, for pyrolysis of contaminants.

The enamel composition helps to increase the lifespan of enamel by suppressing defects of the enamel. The enamel composition helps to remove defects readily without increasing costs, since a raw material for glass frits is used as mill addition.

A novel preparation method of an enamel composition ensuring an excellent cleaning function and excellent thermal shock resistance according to the present disclosure is provided.

Specific effects are described along with the above-described effects in the section of detailed description.

### BRIEF DESCRIPTION OF DRAWINGS

The accompanying drawings constitute a part of the specification, illustrate one or more embodiments in the disclosure, and together with the specification, explain the disclosure.

FIG. 1 is a front view showing a cooking appliance in embodiments.

FIG. 2 is a picture showing that the surface of enamel is chipped.

FIG. 3 is a picture showing results of a thermal shock resistance test in embodiments and comparative examples.

### DETAILED DESCRIPTION

The above-described aspects, features and advantages are specifically described hereafter with reference to accompanying drawings such that one having ordinary skill in the art to which the present disclosure pertains can embody the technical spirit of the disclosure easily. In the disclosure, detailed description of known technologies in relation to the subject matter of the disclosure is omitted if it is deemed to make the gist of the disclosure unnecessarily vague. Hereafter, preferred embodiments according to the disclosure are specifically described with reference to the accompanying drawings. In the drawings, identical reference numerals can denote identical or similar components.

When any one component is described as being “at the upper part (or lower part)” or “on (or under)” another component, any one component can be directly on (or under) another component, but an additional component can be interposed between any one component and another component on (or under) any one component.

When any one component is described as being “connected”, “coupled”, or “connected” to another component, any one component can be directly connected or coupled to another component, but an additional component can be “interposed” between the two components or the two components can be “connected”, “coupled”, or “connected” by an additional component.

Throughout the disclosure, each component can be provided as a single one or a plurality of ones, unless stated to the contrary.

Throughout the disclosure, the singular forms “a”, “an” and “the” are intended to include the plural forms as well, unless explicitly indicated otherwise. It is to be understood that the terms “comprise” or “include” and the like, set forth herein, are not interpreted as necessarily including all the stated components or steps, but can be interpreted as excluding some of the stated components or steps or can be interpreted as including additional components or steps.

Throughout the disclosure, the phrase “A and/or B” as used herein can denote A, B or A and B, and the phrase “C to D” can denote C or greater and D or less, unless stated to the contrary.

Hereafter, an enamel composition, a preparation method thereof and a cooking appliance are described in several embodiments.

### Enamel Composition

An enamel composition according to the present disclosure comprises glass frits, a siloxane-based compound, a silane-based compound and mill addition comprising one or more that is selected from a group comprised of SiO₂, Al₂O₃, ZrO₂ and TiO₂.

The enamel composition according to the present disclosure comprises glass frits. Though not limited, the glass frits may comprise 13.5 to 17 wt% of P₂O₅, 30.3 to 37.6 wt% of SiO₂, 3.8 to13 wt% of Al₂O₃, 0.8 to 4.1 wt% of ZrO₂, 7.8 to 14.5 wt% of Na₂O, 2.3 to 4.5 wt% of K₂O, 0.4 to 1.6 wt% of LiO₂, 14.1 to 19.6 wt% of B₂O₃, 0.1 to 0.6 wt% of TiO₂, 1.8 to 6.9 wt% of NaF, 0.8 to 1.2 wt% of CoO, 0.1 to 0.6 wt% of MnO₂, 0.3 to 1.4 wt% of NiO, 0.1 to 4.3 wt% of Fe₂O₃, and 0.5 to 7.5 wt% of one or more of CaO and MgO, with respect to 100 wt% of the glass frits, to improve the chemical resistance, thermal properties and exterior features of enamel.

The enamel composition according to the present disclosure comprises a siloxane-based compound, and a silane-based compound. The siloxane-based compound and the silane-based compound are added to improve the functionality of the enamel composition. The siloxane-based compound and the silane-based compound help to improve dispersion properties at a time when the enamel composition is coated and to improve the mechanical properties of an enamel coating layer that is formed based on the enamel composition.

Preferably, the siloxane-based compound may comprise polymethylhydrosiloxane or polydimethylsiloxane.

The silane-based compound may comprise an amino silane-based compound, and for example, a compound such as amino propyl trimethoxy silane may be used as the silane-based compound.

The enamel composition according to the present disclosure comprises mill addition comprising one or more that is selected from a group comprised of SiO₂, Al₂O₃, ZrO₂ and TiO₂, to prevent defects such as chipping from being formed on the surface of enamel.

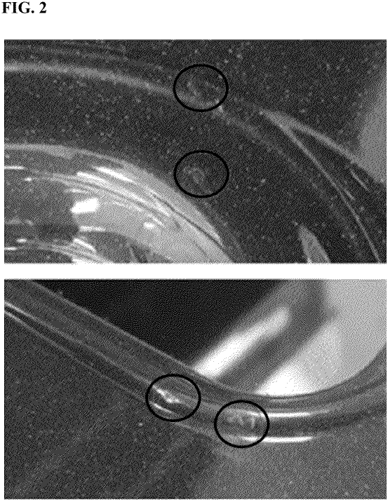

As described above, while temperature drops from high temperature to room temperature, residual stress occurs due to a difference between the coefficient of thermal expansion of a base material and the coefficient of thermal expansion of enamel, and the residual stress may cause defects such as chipping on the surface of the enamel. Referring to FIG. 2, it is often found that the machining model part or edge part of the cavity and door frame of an oven is chipped.

The enamel composition according to the present disclosure may suppress the occurrence of defects such as chipping since the mill addition is added to the enamel composition.

While an enamel coating using the enamel composition is burned, gas such as N₂, CO₂, CO, H₂ and the like is released from the base material, and is trapped in the enamel coating and forms a bubble structure.

The bubble structure is affected by the viscosity of enamel, and ordinarily, in a big-sized bubble, a crack may be caused easily by an impact and stress. In the case where mill addition comprising one or more that is selected from a group comprised of SiO₂, Al₂O₃, ZrO₂ and TiO₂ is added to an enamel composition, the addition of mill addition to the enamel composition affects the viscosity of enamel, thereby making it possible to control the bubble structure.

Preferably, the mill addition has a particle size of 50 to 100 µm, thereby making it easy to control the bubble structure that is formed because of the generation of gas.

Additionally, the enamel composition according to the present disclosure may comprise 85 to 99.75 wt% of the glass frits, 0.1 to 2.5 wt% of the siloxane-based compound, 0.05 to 2.5 wt% of the silane-based compound, and 0.1 to 10 wt% of the mill addition. Since the enamel composition according to the present disclosure has the above content range, the bubble structure formed based on the generation of gas may be easily controlled.

The enamel composition according to the present disclosure comprises the glass frits, the siloxane-based compound, the silane-based compound, and the mill addition, as described above, to suppress defects such as chipping formed on the surface of enamel.

### Preparation Method of Enamel Composition

The preparation method of an enamel composition according to the present disclosure comprises preparing and melting a glass frit material, cooling the material and preparing glass frits, adding mill addition comprising one or more that is selected from a group comprised of SiO₂, Al₂O₃, ZrO₂ and TiO₂, a siloxane-based compound and a silane-based compound to the glass frits and preparing a mixture, and stirring and grinding the mixture.

After the glass frit material is sufficiently mixed, a material for the enamel composition is melted. Preferably, the material for the composition may be melted with a temperature range of 1200 to 1500° C. Additionally, the material for the composition may be melted for 1 to 2 hours.

Then the melted composition may be rapidly cooled by a quenching roller, with a chiller and the like. Accordingly, the glass frits may be prepared.

Then the mill addition comprising one or more that is selected form a group comprised of SiO₂, Al₂O₃, ZrO₂ and TiO₂, the siloxane-based compound and the silane-based compound are added to the glass frits, to prepare a mixture.

Herein, particles having a particle size of 50 to 100 µm may be used as the mill addition. Additionally, the siloxane-based compound may comprise polymethylhydrosiloxane or polydimethylsiloxane. Further, the silane-based compound may comprise an amino silane-based compound, and for example, a compound such as amino propyl trimethoxy silane may be used as the silane-based compound.

After the preparation of the mixture, the mixture is stirred and ground, to prepare an enamel composition. The grinding step may be carried out based on the ball milling method, and the grinding process may be performed for about 4 to 6 hours.

After the stirring and grinding steps, the particle size of the enamel composition may be adjusted to about 50 µm.

### Cooking Appliance

Then the enamel composition according to the present disclosure may be coated on one surface of a target object, on which the composition is to be coated. The target object may be some or all of a metal plate, a glass plate, and a part of a cooking appliance. Preferably, the enamel composition according o the present disclosure may be coated on the exterior of a cooking appliance, which cannot be treated thermally.

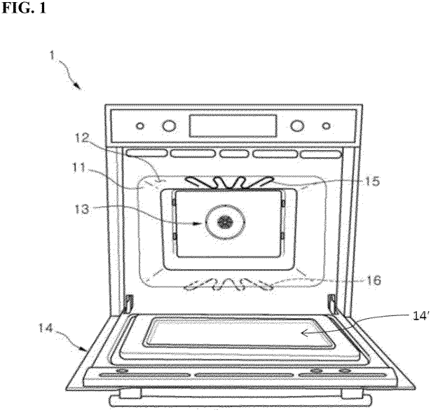

Referring to FIG. 1, a cooking appliance 1 according to the present disclosure comprises a cavity 11 having a cooking space, a door 14 selectively opening and closing the cooking space, at least one heat source 13, 15, 16 providing heat for heating a cooking target in the cooking space, and a coating layer that is formed by an enamel composition according to the present disclosure and coated on the inner surface of the cavity 11 or the door 14.

The cavity 11 may be formed into a cuboid having an open front surface. The heat source 13,15,16 may comprise a convention assembly 13 allowing heated air to be discharged into the cavity 11, an upper heater 15 being disposed on the cavity 11, and a lower heater 16 being disposed under the cavity 11. The upper heater 15 and the lower heater 16 may be provided inside or outside the cavity 11. The heat source 13, 15, 16 may not necessarily include the convection assembly 13, the upper heater 15 and the lower heater 16. That is, the heat source 13,15,16 may comprise any one or more of the convection assembly 13, the upper heater 15 and the lower heater 16.

The enamel composition according to the present disclosure may be coated on the inner surface of the cavity 11, the door 14 or the door glass 14′ of the cooking appliance 1, based on the dry process or the wet process. The cavity 11 and the door 14 may be made of a metal plate, and the coating layer using the enamel composition according to the present disclosure may be directly coated on the metal plate, as a single layer.

Additionally, the enamel composition according to the present disclosure may be applied to a cooking appliance comprising a glass plate, and at least one of heat sources, which is disposed under the glass plate. The coating layer formed by a glass composition according to the present disclosure may be disposed on the glass plate.

Hereafter, detailed aspects according to the present disclosure are described based on embodiments.

### Embodiments

### < Preparation of Glass Composition>

Glass frits having composition ratios listed in table 1 hereafter were manufactured. A raw material for each component was sufficiently mixed for three hours in a V-mixer. Herein, NH₄H₂PO₄ was used as a raw material for P₂O₅. Na₂CO₃, K₂CO₃, and Li₂CO₃ were respectively used as a raw material for Na₂O, K₂O, and Li₂O. The remaining components are listed in table 1. The mixed materials were sufficiently melted for one and a half hours at 1300° C. and were rapidly cooled in a quenching roller. Then glass frits were obtained.

TABLE 1

| Component | Ratio (wt%) |
|---|---|
| P2O5 | 14.5 |
| SiO2 | 33.3 |
| B2O3 | 18.2 |
| Na2O | 12.2 |
| K2O | 4.1 |
| Li2O | 0.8 |
| Al2O3 | 5.5 |
| ZrO2 | 2.1 |
| TiO2 | 0.3 |
| NaF | 4.3 |
| CaO | 1.3 |
| MgO | 1.3 |
| CoO | 0.9 |
| MnO2 | 0.1 |
| NiO | 0.3 |
| Fe2O3 | 0.8 |

Additives listed in table 2 hereafter were added to the glass frits obtained through the above steps to prepare a mixture, and the mixture was ground for about five hours with a grinder (ball mill) and then passed through a 325 mesh sieve (ASTM C285-88). Powders having passed through the mesh sieve had a particle size of about 45 µm or less, and were used as an enamel composition.

TABLE 2

(Unit: wt%)

| Component | Comparative example | Embodiment 1 | Embodiment 2 | Embodiment 3 |
|---|---|---|---|---|
| Glass frit | 99.8 | 99.1 | 99.1 | 99.09 |
| Mill addition | 0 | SiO2 0.6 | SiO2 0.5 | SiO2 0.3 |
| | | Al2O3 0.1 | Al2O3 0.1 | Al2O3 0.1 |
| | | | ZrO2 0.1 | TiO2 0.3 |
| Polymethylhydrosiloxan e | 0.15 | 0.15 | 0.13 | 0.15 |
| Amino silane | 0.05 | 0.05 | 0.07 | 0.06 |

### < Preparation of Enamel Composition Sample>

The enamel composition prepared as described above sprayed on a stainless steel plate of 200×200 mm and thickness of 1 mm or less with an ordinary corona discharge gun. The voltage of the discharge gun was controlled under the conditions of 40 kV to 100 kV. The sample was burned for 300 to 450 seconds at about 850° C.

### Experimental Example-thermal Shock Resistance

The thermal shock resistance of the samples in the embodiments and comparative example was evaluated as described hereafter.
1) Thermal shock resistance test-rapid cooling resistance test (KS D 9403)
   The samples were heated for 20 minutes in a thermostat of 230° C. and then taken out of the thermostat, and put into water of room temperature, to see if there is a line crack or a separation.
2) Thermal shock resistance test -harsh condition test
   The samples were heated for 60 minutes in a thermostat of 400° C. and then taken out of the thermostat, and put into water of room temperature, to see if there is a separation.

TABLE 3

| | | | | |
|---|---|---|---|---|
| Thermal shock resistance test | Comparative example | Embodiment 1 | Embodiment 2 | Embodiment 3 |
| Rapid cooling resistance test | No abnormality | No abnormality | No abnormality | No abnormality |
| Harsh condition test | Separation | No abnormality | No abnormality | No abnormality |

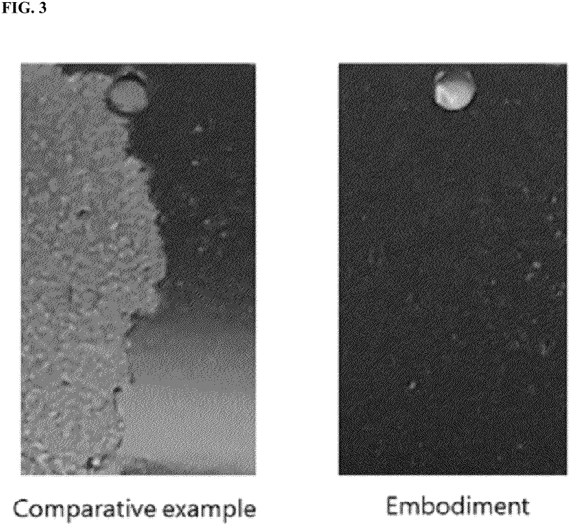

In the above table, the rapid cooling resistance test showed no abnormality of the embodiments and the comparative example. However, the harsh condition test showed that the enamel coating layer separated from the base material in the comparative example. The separation between the base material and the enamel coating layer might be caused by bubbles generated by gas that was produced from the base material because of high temperature. FIG. 3 shows a picture showing the surfaces of the comparative example and embodiment 1. Referring to FIG. 3, there is a separation on the surface of the comparative example, while there is no separation on the surface of embodiment 1.

The embodiments are described above with reference to a number of illustrative embodiments thereof. However, embodiments are not limited to the embodiments and drawings set forth herein, and numerous other modifications and embodiments can be made by one skilled in the art within the technical scope of the disclosure. Further, the effects and predictable effects based on the configurations in the disclosure are to be included within the scope of the disclosure though not explicitly described in the description of the embodiments.

Description of Reference Numerals

| | |
|---|---|
| 1 | Cooking Appliance |
| 11 | Cavity |
| 12 | Cooking Space |
| 13 | Convection Assembly |
| 14 | Door |
| 14′ | Door Glass |
| 16 | Lower Heater |

What is claimed is:

1. An enamel composition, comprising:
glass frits;
a siloxane-based compound;
a silane-based compound; and
a mill addition comprising one or more components selected from a group comprised of SiO₂, Al₂O₃, ZrO₂, and TiO₂.

2. The enamel composition of claim 1, wherein the enamel composition comprises:
85 to 99.75 wt% of the glass frits;
0.1 to 2.5 wt% of the siloxane-based compound;
0.05 to 2.5 wt% of the silane-based compound; and
0.1 to 10 wt% of the mill addition.

3. The enamel composition of claim 1, wherein the mill addition has a particle size of 50 to 100 µm.

4. The enamel composition of claim 1, wherein the glass frits comprise:
13.5 to 17 wt% of P₂O₅;
30.3 to 37.6 wt% of SiO₂;
3.8 to 13 wt% of Al₂O₃;
0.8 to 4.1 wt% of ZrO₂;
7.8 to 14.5 wt% of Na₂O;
2.3 to 4.5 wt% of K₂O;
0.4 to 1.6 wt% of LiO₂;
14.1 to 19.6 wt% of B₂O₃;
0.1 to 0.6 wt% of TiO₂;
1.8 to 6.9 wt% of NaF;
0.8 to 1.2 wt% of CoO;
0.1 to 0.6 wt% of MnO₂;
0.3 to 1.4 wt% of NiO;
0.1 to 4.3 wt% of Fe₂O₃; and
0.5 to 7.5 wt% of one or more of CaO and MgO, with respect to 100 wt% of the glass frits.

5. The enamel composition of claim 1, wherein the siloxane-based compound comprises polymethylhydrosiloxane or polydimethylsiloxane.

6. The enamel composition of claim 1, wherein the silane-based compound comprises amino silane.

7. A preparation method of an enamel composition, comprising:
preparing and melting a glass frit material;
cooling the material and preparing glass frits;
adding mill addition comprising one or more that is selected from a group comprised of SiO₂, Al₂O₃, ZrO₂ and TiO₂, a siloxane-based compound, and a silane-based compound to the glass frits and preparing a mixture; and
stirring and grinding the mixture.

8. The preparation method of claim 7, wherein the mixture comprises:
85 to 99.75 wt% of the glass frits;
0.1 to 2.5 wt% of the siloxane-based compound;
0.05 to 2.5 wt% of the silane-based compound; and
0.1 to 10 wt% of the mill addition.

9. The preparation method of claim 7, wherein the mill addition has a particle size of 50 to 100 µm.

10. The preparation method of claim 7, wherein the glass frit material comprises:
13.5 to 17 wt% of P₂O₅;
30.3 to 37.6 wt% of SiO₂;
3.8 to 13 wt% of Al₂O₃;
0.8 to 4.1 wt% of ZrO₂;
7.8 to 14.5 wt% of Na₂O;
2.3 to 4.5 wt% of K₂O;
0.4 to 1.6 wt% of LiO₂;
14.1 to 19.6 wt% of B₂O₃;
0.1 to 0.6 wt% of TiO₂;
1.8 to 6.9 wt% of NaF;
0.8 to 1.2 wt% of CoO;
0.1 to 0.6 wt% of MnO₂;
0.3 to 1.4 wt% of NiO;
0.1 to 4.3 wt% of Fe₂O₃; and
0.5 to 7.5 wt% of one or more of CaO and MgO, with respect to 100 wt% of the glass frits.

11. The preparation method of claim 7, wherein the siloxane-based compound comprises polymethylhydrosiloxane or polydimethylsiloxane.

12. The preparation method of claim 7, wherein the silane-based compound comprises amino silane.

13. A cooking appliance, comprising:
a cavity having a cooking space;
a door selectively opening and closing the cooking space;
at least one heat source providing heat for heating a cooking target in the cooking space; and
a coating layer that is formed by the enamel composition of claim 1 and coated on one of an inner surface of the cavity, an inner surface of the door, and an inner surface of a door glass being disposed at the door.

14. A cooking appliance, comprising:
a glass plate;
at least one heat source being disposed under the glass plate; and
a coating layer being coated on an upper surface of the glass plate and formed by the enamel composition of claim 1.
